(19) United States
(12) Patent Application Publication
(10) Pub. No.: US 2025/0110820 A1
(43) Pub. Date: Apr. 3, 2025

(54) SYSTEMS AND METHODS FOR A REAL TIME ANOMALY STREAMING MODULE

(71) Applicant: Fidelity Information Services, LLC, Jacksonville, FL (US)

(72) Inventors: Ranadhir GHOSH, St Johns, FL (US); John C. PLATAIS, Menomonee Falls, WI (US); Ross P. ELLISON, West Windsor, NJ (US)

(21) Appl. No.: 18/962,292

(22) Filed: Nov. 27, 2024

Related U.S. Application Data
(63) Continuation-in-part of application No. 18/478,106, filed on Sep. 29, 2023.

(51) Int. Cl. G06F 11/07

(52) U.S. Cl. CPC G06F 11/079; G06F 11/0709

(57) ABSTRACT

A method for processing live streaming data includes assigning one or more data to one or more windows based on group level characteristics of the one or more data, assigning the one or more data to one or more sub-windows based on one or more time stamps, the one or more sub-windows inside the windows, creating a data count for each of the sub-windows, creating a first time series from the data count of each of the sub-windows, comparing the time series to a second time series of data, wherein the second time series of data is previous time series data, identifying presence of one or more anomalies based on the comparison of first time series to the second time series, alerting a user to the presence of anomalies based on a result of the comparison, and modifying the second time series based on the first time series.

### CROSS-REFERENCE TO RELATED APPLICATION(S)

This patent application is a continuation-in-part of and claims the benefit of priority to U.S. application Ser. No. 18/478,106, filed on Sep. 29, 2023, the entirety of which is incorporated herein by reference.

### TECHNICAL FIELD

Various embodiments of the present disclosure relate generally to information technology (IT) management systems and, more particularly, to systems and methods for a real time anomaly streaming module.

### BACKGROUND

In computing systems, for example computing systems that perform financial services and electronic payment transactions, programing changes may occur. For example, software may be updated. Changes in the system may lead to incidents, defects, issues, bugs or problems (collectively referred to as incidents) within the system. These incidents may occur at the time of a software change or at a later time. These incidents may be costly for the company as users may not be able to use the services and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

In the field of data processing, handling vast volumes of data in real-time to determine quick, data-driven decisions such as anomaly detection may be challenging. The present disclosure is directed to addressing this and other drawbacks to the existing computing system analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for processing live streaming data, the method including: assigning one or more data to one or more windows based on one or more group level characteristics of the one or more data; assigning the one or more data to one or more sub-windows based on one or more time stamps, the one or more sub-windows inside the windows; creating a data count for each of the sub-windows, wherein the data count is a scalar value; creating a first time series from the data count of each of the sub-windows, wherein the first time series of the data is a real-time synchronous time series of data; comparing the time series to a second time series of data, wherein the second time series of data is previous time series data; identifying presence of one or more anomalies based on the comparison of first time series to the second time series, wherein the comparison is based on comparison of the scalar values; alerting a user to the presence of one or more anomalies based on a result of the comparison; and modifying the second time series based on the first time series.

In some aspects, the techniques described herein relate to a method, wherein the method is implemented using an application programming interface with a unified stream-processing and batch-processing framework.

In some aspects, the techniques described herein relate to a method, wherein the sub-windows are fixed size, non-overlapping, contiguous time interval windows.

In some aspects, the techniques described herein relate to a method, wherein the sub-windows are sliding windows.

In some aspects, the techniques described herein relate to a method, wherein group level characteristics include impacted data centers, configurable item category, impacted locations, impacted line of businesses, and impacted alert sources.

In some aspects, the techniques described herein relate to a method, wherein the one or more windows is seven days.

In some aspects, the techniques described herein relate to a method, wherein the one or more windows is twenty-four hours.

In some aspects, the techniques described herein relate to a method, wherein a time interval of the one or more sub-windows is five minutes or less.

In some aspects, the techniques described herein relate to a method, wherein the second time series is a mathematical average of previously collected time series data.

In some aspects, the techniques described herein relate to a method, wherein the comparing includes comparing the first time series with the second time series at every sub-window interval.

In some aspects, the techniques described herein relate to a method, wherein the comparing including comparing the first time series with the second time series at a user specified time interval.

In some aspects, the techniques described herein relate to a computer-implemented method for processing live streaming data, the method including: storing one or more distance profiles of one or more subsequences for a first time series of data, into a matrix profile that is a vector; storing one or more minimum distances between each of the one or more subsequences into the matrix profile; identifying one or more repeated patterns in the first time series of data using a value of the matrix profile at one or more times; identifying one or more top discords in the first time series of data using a value of the matrix profile at the one or more times; stopping one or more false alerts from being sent based on a determination that the first time series of data is made up of the one or more repeated patterns; and outputting one or more alerts based on identification of top discords.

In some aspects, the techniques described herein relate to a method, wherein the matrix profile allows a comparison of one or more time period's data value to previously collected time period's data value to identify if the one or more time period is having a unique flow of data compared to the previously collected time period data.

In some aspects, the techniques described herein relate to a method, wherein the one or more repeated patterns include spikes or drops.

In some aspects, the techniques described herein relate to a method, wherein a matrix profile with a lower value corresponds with identification of one or more repeated patterns.

In some aspects, the techniques described herein relate to a method, wherein the one or more top discords include sudden spikes or sudden drops.

In some aspects, the techniques described herein relate to a method, wherein a higher value matrix profile corresponds with identification of one or more top discords.

In some aspects, the techniques described herein relate to a method, wherein a higher value matrix profile indicates to a user, a higher likelihood that an area that appears anomalous is actually anomalous compared to areas that are not anomalous; and a lower likelihood that an identified area is the type of data expected to be seen or seen before compared to previously time series of data.

In some aspects, the techniques described herein relate to a method, wherein the method is implemented using an application programming interface with a unified stream-processing and batch-processing framework.

In some aspects, the techniques described herein relate to a system for determining group-level anomalies for information technology events, the system including: a memory having processor-readable instructions stored therein; and at least one processor configured to access the memory and execute the processor-readable instructions to perform operations including: assigning one or more data to one or more windows based on one or more group level characteristics of the one or more data; assigning the one or more data to one or more sub-windows based on one or more time stamps, the one or more sub-windows inside the windows; creating a data count for each of the sub-windows, wherein the data count is a scalar value; creating a first time series from the data count of each of the sub-windows, wherein the first time series of the data is a real-time synchronous time series of data; comparing the time series to a second time series of data, wherein the second time series of data is previous time series data; identifying presence of one or more anomalies based on the comparison of first time series to the second time series, wherein the comparison is based on comparison of the scalar values; alerting a user to the presence of one or more anomalies based on a result of the comparison; modifying the second time series based on the first time series; storing one or more distance profiles of one or more subsequences for the first time series of data, into a matrix profile that is a vector; storing one or more minimum distances between each of the one or more subsequences into the matrix profile; identifying one or more repeated patterns in the first time series of data using a value of the matrix profile at one or more times; identifying one or more top discords in the first time series of data using a value of the matrix profile at the one or more times; stopping one or more false alerts from being sent based on a determination that the first time series of data is made up of the one or more repeated patterns; and outputting one or more alerts based on identification of top discords.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence module to predict and troubleshoot incidents in a system, according to one or more embodiments.

FIG. 2 depicts a flowchart for a process of real-time stream data processing, according to one or more embodiments.

FIG. 3A depicts a graph of tumbling windows implemented by the system herein, according to one or more embodiments.

FIG. 3B depicts a chart of exemplary alert category level anomaly, according to one or more embodiments.

FIG. 4A depicts exemplary determine matrix profiles and stream profiles, according to one or more embodiments.

FIG. 4B depicts exemplary determine matrix profiles and stream profiles, according to one or more embodiments.

FIG. 5 illustrates a computer system for executing the techniques described herein, according to one or more embodiments of the present disclosure.

FIG. 6 depicts graphs of time series of data, according to one or more embodiments.

FIG. 7 depicts exemplary determine matrix profiles and stream profiles, according to one or more embodiments.

FIG. 8 depicts a graph of sliding windows implemented by the system herein, according to one or more embodiments.

### DETAILED DESCRIPTION OF EMBODIMENTS

Various embodiments of the present disclosure relate generally to information technology (IT) management systems and, more particularly, to systems and methods for a real time anomaly streaming module.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an IT system. The system described herein may for example receive a stream of event data over periods of time. Event data may include, but is not limited: (1) an incident, (2) an alert, (3) change data, (4) a problem; and/or an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber-attacks. Deploying, refactoring, or releasing software code may for example cause an incident. An incident may be detected during, for example, an outage or a performance change. An incident may include characteristics, where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

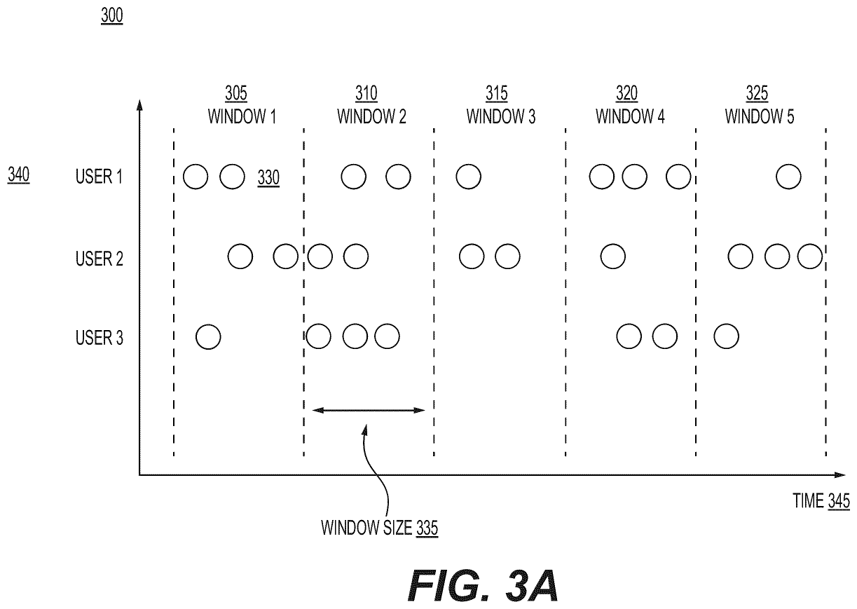

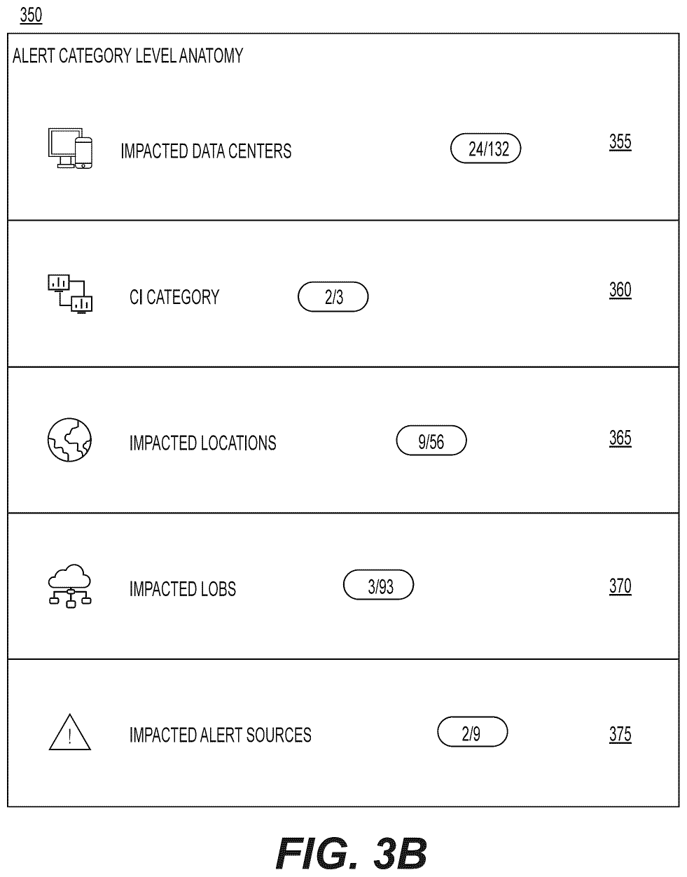

Change data may refer to information that described a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation. Exemplary anomalies may be depicted in FIG. 3B. FIG. 3B depicts a chart 350 of exemplar alert category level anomaly, according to one or more embodiments. Alerts may for example impact data centers, particular configurable items (CIs), locations, LOBs, and alert sources.

Event data may be associated with one or more configurable items (CIs). A configurable item (CI) may refer a component of a system that can be identified as a self-contained unit for purposes of change control and identification. For example, a particular application, service, particular product, or server may be defined by a CI.

The system described herein may be configured to handle vast volumes of data in real-time to make quick, data-driven decisions which may be crucial to ensure service level agreement (SLA) requirements and continuous uptime of all applications.

Conventional system may have latency issues, scalability issues, timeliness of insight issues, and/or anomaly detection, or some other term as discussed below.

Regarding latency, conventional systems may include batch processing that may collect data over a certain period, then process the data as a group. This may inherently introduces latency as a user may need to wait for the batch to be complete before the system can start processing. In contrast, stream processing applied by the system described herein, may allow for real-time data processing, thereby drastically reducing latency. This may be crucial in scenarios where immediate action is required or desirable based on incoming data.

Scalability: For conventional systems, as volume of data grows, batch processing becomes increasingly complex and resource intensive. In contrast, stream processing applied by the system described herein, may be more scalable since it processes data one event at a time.

Timeliness of insights: Conventional systems utilizing batch processing may often leads to outdated insights due to the time lag between data collection and processing. In contrast, stream processing applied by the system described herein can derive insights in real time, which is valuable to sectors of data streams such as financial technology where SLA may need to be met.

Regarding anomaly detection, conventional system utilizing batch processing, may detect anomalies too late, rendering any remedial action ineffective or delayed. Real time anomaly detection, incorporated by the system described herein, may allow for immediate detection and response to any anomalies that need to be addressed.

The system described herein may for example be configured to make real-time decision making, provide continuous learning, be cost efficient, handle unstructured data, and/or handle different types of anomalies.

One or more embodiments may provide real-time stream data processing detection of anomalies. One or more embodiments may provide near real-time stream data processing detection of anomalies, with only slight delay between processing and result viewing.

One or more embodiments may include real-time processing. Conventional systems may only allow for anomaly detection on data that has already been stored, not as it is coming in real time. In these conventional systems, by the time the anomaly has been identified, the damage from said anomaly may have already occurred, rendering the identification of the anomaly useless. The system described herein may incorporate tumbling windows with synchronous real time statistical anomaly detection that allows for grouped sources of anomalous data to be detected. Matrix profiling discords may display in real time exactly how anomalous the current incoming data is.

One or more embodiments may be scalable. The system may include one or more anomaly detection algorithms that can be distributed to as many data sources as necessary and grouped into any hierarchy able to handle large volumes of streaming data efficiently and accurately. The real-time analysis may persist no matter how large the processes are distributed.

One or more embodiments may include flexibility with windowing. For example, one or more embodiments of sliding windows may include having a 10 minute window sample, not having 10 sliding windows, but instead having a window between 1 minutes and 2 minutes, then 2 minutes and 3 minutes, then 3 minutes and 4 minutes, incrementing by a time stamp, across the entire 10 minute window sample. In one or more embodiments, sliding windows may include window 1 which is between 1 minute and 2 minutes of the 10 minute window. In one or more embodiments, sliding windows may include a window that is 10 minutes, and one or more sub-windows between 1 minute and 2 minutes, 2 minutes and 3 minutes, and 3 minutes and 4 minutes.

The use of tumbling windows for group-level anomaly detection may provide the flexibility to adjust the window size based on the specific characteristics of each data group. This may be an advantage over conventional systems that use fixed window sizes as it allows for a more granular and relevant analysis. For example, one or more embodiments of tumbling windows may include a window that is 7 days, and a distance between vertical lines in the window that is 5 minutes. One or more embodiments may include sliding windows that include a window that is 7 days, and sliding sub-windows that are 5 minutes in length. One or more embodiments may include comparing a larger 7 day window that is a fingerprint, then comparing that 7 day window fingerprint (made up of 5 scalar values) and every 5 minutes comparing new metrics with the old fingerprint. For example, one or more embodiments may include each new 7 day window being created or updated every 5 minutes. One or more embodiments may include when a new 7 day window is different in a 5 minute sub-window of that new 7 day window compared to an old 7 day window being used as a fingerprint, the identification of an anomaly.

One or more embodiments may utilize advanced anomaly detection. The techniques described herein may uses advanced techniques in real time to detect true anomalies in real time with minimal false positives. At the group level statistical algorithms can detect anomalous spikes in data and at the individual level matrix profiles.

One or more embodiments may allow for various types of data processing in order to identify correlations, similarity, and root causes, and recommend a corrective action based on received data as well as user feedback mechanisms. One or more embodiments may be extended to clients and users of services and software with applications that are connected to the system described herein.

One or more embodiments may use an application programming interface with a unified stream-processing and batch-processing framework such as PyFlink, a Python API for Apache Flink, for real-time stream data processing. One or more embodiments may find anomalous patterns in data that may need to be addressed in real-time. Hundreds of thousands of individual data sources may create data. One or more embodiments of sources may include computers, computer systems, or individual components, sub-components, or subsystems of computers or computer systems. One or more embodiments may include each individual data source or piece of incoming data may be categorized into a group. Each source may be monitored individually and may be monitored as part of a group in an application programming interface with a unified stream-processing and batch-processing framework, such as PyFlink. Each data source as well as groups of data sources may be analyzed in real time. Real time anomaly detection may occur on the individual and group level.

One or more embodiments may include group-level anomaly detection with tumbling windows or sliding windows. Tumbling windows are a type of windowing mechanism in stream processing that may group elements into a fixed size, non-overlapping and contiguous time intervals. One or more embodiments may include custom time intervals for tumbling windows based on the specific characteristics of each data group. Tumbling windows may capture the temporal patterns within each data group. Using tumbling windows may result in asynchronous data of counts in each window for each group of data. A system may convert the data into a synchronous time series depending on the specifications of the data and grouping. As each new window of data streams in it may be turned into a standardized value that uses a specific amount of synchronous time series data to compare with previously collected time series data. With that comparison a user or system may get a good understanding of statistically whether or not the current window of data is anomalous.

One or more embodiments may include alert data source anomaly detection with matrix profile. Matrix profile is a technique which may be utilized for time series anomaly detection. Matrix profile may involve computing a distance profile of each subsequence within a time series then combining these distance profiles into a matrix profile, which also may be a vector that stores the minimum distance of each subsequence to all others. The matrix profile may allow a user or system to accomplish two main criteria that may be particularly important in order to detect anomalies without relying on sudden spikes or drops. One or more embodiments may include a matrix profile that includes repeated patterns. Alerts may be sent out on intervals whether or not there is a problem. For example, one or more embodiments may provide a business that sets up agents, and an alert may be sent based on a threshold, or sent if a threshold is not met. The matrix profile may allow a user or system to see the patterns, for example one or more embodiments may include highlights that may show a pattern of two spikes that are extremely similar to each other. Alert data in the two or more highlights may behave in almost the exact same pattern. While a basic anomaly detection might just pick up a sharp increase in data, the matrix profile may allow a user or system to compare one time period's spike to multiple or all other time period's within the data to see if each particular time period is having a unique flow of data compared to the others. One or more embodiments may provide an indication of the likelihood of the presence of an anomaly. One or more embodiments may provide a higher value matrix profile, which may indicate a lower likelihood that a time period's data is relational to any of the data it is being compared to. One or more embodiments may include top discords. The matrix profiling algorithm may allow periods of incoming data to be compared with other periods of incoming data. One or more embodiments may provide that the higher the value of the matrix profile, the higher the discord, and the less similar it is to all other periods in the time series. Using the discords a user or system may be able to find true anomalies as the alert data comes in that is unlike any of the other alert data coming in without having to rely on sudden spikes or drops. One or more embodiments may provide a top discord that shows the period of data that is unlike most of all the other periods of data. High values on matrix profile may allow a user or system to better examine areas that appear anomalous compared to those that are not and give us a better indication of whether or not this type of data is expected and seen before, or anomalous, and just how anomalous the data is, for example one or more embodiments providing the likelihood of data being anomalous.

Two key techniques may be used in stream-data processing: windowing for group-level anomaly detection and matrix profile for individual data source anomaly detection. Both techniques may be implemented using PyFlink.

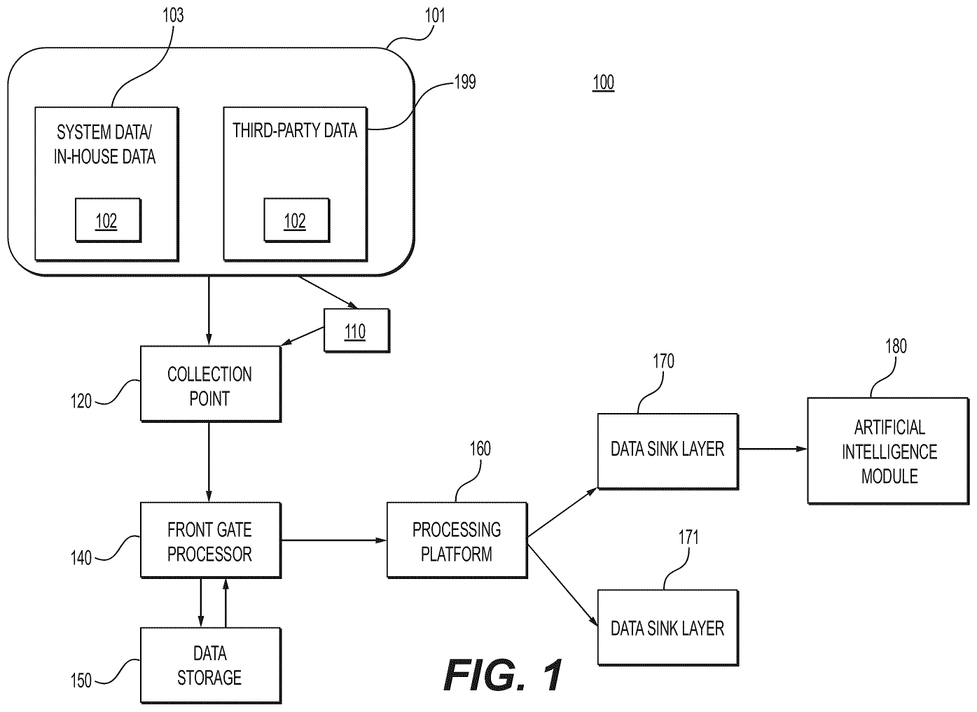

FIG. 1 depicts an exemplary system overview for a data pipeline for an artificial intelligence module to predict and troubleshoot incidents in a system, according to one or more embodiments. For example, the data pipeline system 100 may aggregate and send incident data to an artificial intelligence module 180, wherein the artificial intelligence module 180 is configured to aggregate and map incident characteristics into daily incident proles using feature engineering and/or multiple level clustering. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and the artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to the files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., data sink layer 170 and/or data sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to the artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster, PostgreSQL cluster). Further processing may thus be performed prior to the processed data being received by the artificial intelligence module 180.

As discussed, the data pipeline system 100 may include the artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

The system (e.g., data pipeline system 100) described herein may provide real-time stream data processing and anomaly detection. The system may apply real time decision making. Real-time stream processing may allow for immediate decision making based on the most recent data. The system may continuously learn. Stream processing may support a system configured to learn and adapt continuously. For example, models may be updated as new data comes in. The system may be configured to update as new data is received. The system may be cost efficient. Stream processing may better reduce computing, and handle dynamic hanging data without costly crashes. The system may handle unstructured data. Stream processing may be better equipped to handle unstructured data as compared to batch data. The system may be configured to handle different types of anomalies. Not every spike in data may be considered an anomaly. Not properly categorizing anomalies may be expensive and cost recourses. Accurately finding anomalies in data may depend on the type of data and algorithm applied.

The system described herein may for example utilize the processing platform 160. For example, the processing platform may utilize PyFlink for stream data processing. The processing objective may be to find anomalous patterns in data that need real time addressing. The system may be configured to receive thousands of data sources and thousands of different patterns, and the system be configured to find anomalies in real time.

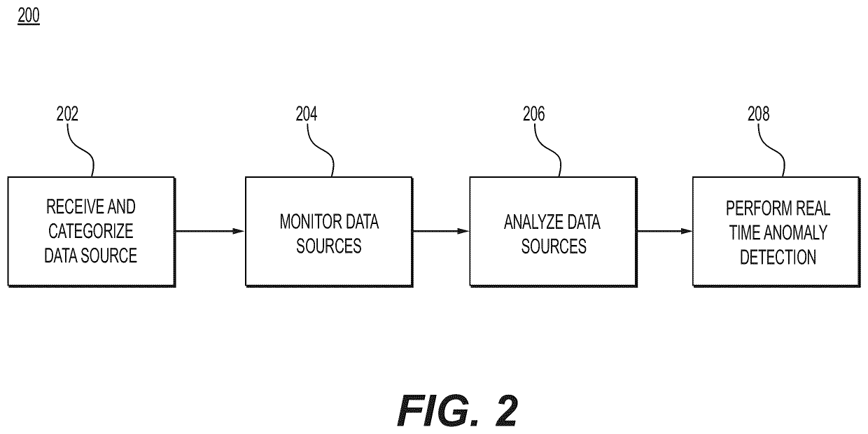

FIG. 2 depicts a flowchart for a process of real-time stream data processing, according to one or more embodiments.

As depicted in flowchart for a process 200, at step 202, the system may for example receive as input individual data sources. For example, the system may be configured to receive hundreds of thousands of individual data sources. The system may be configured to receive greater or fewer than hundreds of thousands of individual data sources. Further, the system may categorize the data sources into a group for common processing. At step 204, the system described herein may monitor the data sources individually and as a group, utilizing the techniques described herein. The system may monitor each data source as part of a group in a framework or a distributed processing engine for stateful computations over unbounded and bounded data streams. The system may include implementation with a Python API for Apache Flink such as PyFlink utilizing the techniques described herein. At step 206, the system described herein may analyze, in real time, data sources and groupings of data. At step 208, the system may apply real time anomaly detection of the individual and group level data sources utilizing the techniques described herein. Step 206 and step 208 may include assigning one or more data to one or more windows based on one or more group level characteristics of the one or more data, assigning the one or more data to one or more sub-windows based on one or more time stamps, the one or more sub-windows inside the windows, creating a data count for each of the sub-windows, wherein the data count is a scalar value, creating a first time series from the data count of each of the sub-windows, wherein the first time series of the data is a real-time synchronous time series of data, comparing the time series to a second time series of data, wherein the second time series of data is previous time series data, identifying presence of one or more anomalies based on the comparison of first time series to the second time series, wherein the comparison is based on comparison of the scalar values, alerting a user to the presence of one or more anomalies based on a result of the comparison, modifying the second time series based on the first time series, storing one or more distance profiles of one or more subsequences for the first time series of data, into a matrix profile that is a vector, storing one or more minimum distances between each of the one or more subsequences into the matrix profile, identifying one or more repeated patterns in the first time series of data using a value of the matrix profile at one or more times, identifying one or more top discords in the first time series of data using a value of the matrix profile at the one or more times, stopping one or more false alerts from being sent based on a determination that the first time series of data is made up of the one or more repeated patterns, and outputting one or more alerts based on identification of top discords. Steps 206 or 208 may further include a system for determining group-level anomalies for information technology events, the system comprising a memory having processor-readable instructions stored therein, and at least one processor configured to access the memory and execute the processor-readable instructions to perform operations including wherein the processor-readable instructions to perform operations are implemented using an application programming interface with a unified stream-processing and batch-processing framework, wherein the system includes a graphical user interface, wherein the system includes physical terminal for a user to access and display information generated by the processor.

The system may for example utilize two techniques in stream-data processing: windowing for group-level anomaly detection and matrix profile for individual data source anomaly detection. Both techniques may be implemented by the processing platform 160.

FIG. 3A depicts a graph of tumbling windows implemented by the system herein, according to one or more embodiments. Windows 300 may include window 1 305, window 2 310, window 3 315, window 4 320, window 5 325, data 330, window size 335, user 1 340, time 345, multiple other users, or multiple other windows. Group-Level anomaly detection may be performed with tumbling windows. Tumbling windows may refer to a type of windowing mechanism in stream processing that groups elements into a fixed size, non-overlapping and contiguous time intervals. The system may utilize custom time intervals for these tumbling windows based on the specific characteristics of each data group, including group level, such as origin of capture (for example, what source or tool) captured the data, the data center where alert was received, the region alert was revived from, or LOB (line of business) associated with alert. One or more embodiments may provide if you do not define any group data may be classified as raw data. One or more embodiments may provide alert agents that are not categorized which may include top level data. One or more embodiments may provide agent levels that may not be important or relevant to an enterprise, or provide ten different agents. One or more embodiments may provide part of the analytics may be trying to figure out a group or trying to classify data into a group. For example, one or more embodiments may provide 35 different implementations of a modern banking platform, and just because one of the implementations is showing an anomaly does not mean that the other implementations are showing an anomaly. One or more embodiments may provide for a user or system setting the group. The use of tumbling windows may capture the temporal patterns within each group of data.

The system may utilize the tumbling windows to obtain asynchronous data of counts in each window for each group of data. The system may then convert the data into a synchronous time series depending on the specifications of the data and grouping. As each new window of data streams in the respective window can be turned into a standardized value that uses a specific amount of synchronous time series data to compare with a previously collected time series of data. With that comparison the system may be configured to output statistically whether or not the current window of data is anomalous. User 1 340 may be one of many users, including user 2 or user 3.

FIG. 3B depicts a chart of exemplary alert category level anomaly, according to one or more embodiments. Chart 350 may include alert category level anomaly. Chart 350 may include impacted data centers 355, particular configurable items (CIs) or CI Category 360, impacted locations 365, Impacted LOBs or impacted line of business 370, and alert sources or Impacted Alert source 375. Alert category level anomalies may include impacted data centers 355, particular configurable items (CIs) or CI Category 360, impacted locations 365, Impacted LOBs or impacted line of business 370, and alert sources or Impacted Alert source 375. Impacted data center 355 may be alerts based on the data center group-level of the collected data. Particular configurable items or CI Category 360 may be alerts based on configurable item group-level of collected data. Impacted locations 365 may be alerts based on geographic location group-level of collected data. Impacted line of business 370 may be alerts based on the line of business group-level of collected data. Impacted Alert source 375 may be the impacted alert source group-level of collected data. Impacted data centers 355, CI Category 360, impacted locations 365, impacted line of business 370, and Impacted Alert source 375, may be one or more alerts which may include data which may be assigned to one or more windows based on their group level characteristics. Also, impacted data centers 355, CI Category 360, impacted locations 365, impacted line of business 370, and Impacted Alert source 375 may be one or more alerts which may include data which may be assigned to one or more sub-windows based on one or more time stamps, the one or more sub-windows which may be inside the windows.

FIG. 3A and FIG. 3B also may depict a computer-implemented method for processing live streaming data, the method comprising assigning one or more data to one or more windows based on one or more group level characteristics of the one or more data; assigning the one or more data to one or more sub-windows based on one or more time stamps, the one or more sub-windows inside the windows; creating a data count for each of the sub-windows, wherein the data count is a scalar value; creating a first time series from the data count of each of the sub-windows, wherein the first time series of the data is a real-time synchronous time series of data; comparing the time series to a second time series of data, wherein the second time series of data is previous time series data; identifying presence of one or more anomalies based on the comparison of first time series to the second time series, wherein the comparison is based on comparison of the scalar values; alerting a user to the presence of one or more anomalies based on a result of the comparison; and modifying the second time series based on the first time series.

FIG. 3A and FIG. 3B also may depict a computer-implemented method for processing live streaming data further comprising wherein the method is implemented using an application programming interface with a unified stream-processing and batch-processing framework, wherein the sub-windows are fixed size, non-overlapping, contiguous time interval windows, wherein the sub-windows are sliding windows, wherein group level characteristics include impacted data centers, configurable item category, impacted locations, impacted line of businesses, and impacted alert sources, wherein the one or more windows is seven days, wherein the one or more windows is seven days or more, wherein the one or more windows is seven days or less, wherein the one or more windows is twenty-four hours, wherein a time interval of the one or more sub-windows is five minutes or less, wherein a time interval of the one or more sub-windows is five minutes or more, wherein the second time series is a mathematical average of previously collected time series data, wherein the comparing comprises comparing the first time series with the second time series at every sub-window interval. For example, one or more embodiments may include a scalar value during the 5 minute time interval at 9:00 AM today, compared to scalar value during 5 minute time interval at 9:00 AM one week ago from today. FIG. 3A and FIG. 3B also may depict a computer-implemented method for processing live streaming data further comprising wherein the comparing comprising comparing the first time series with the second time series at a user specified time interval.

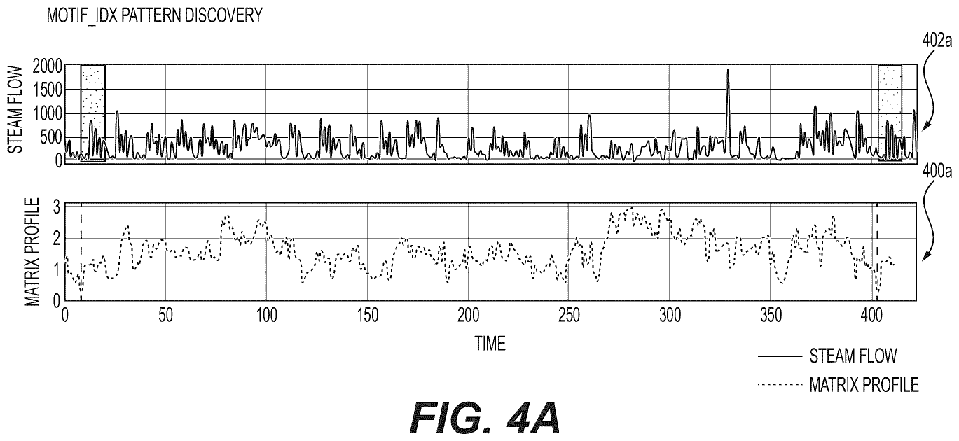

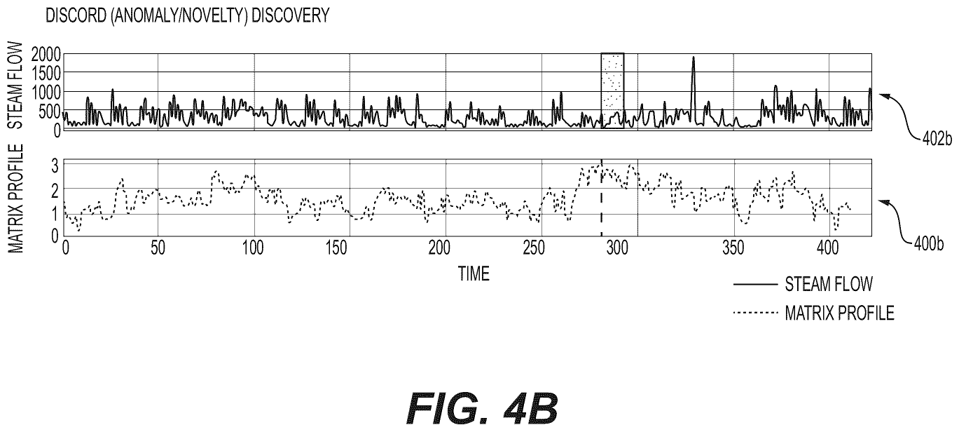

FIG. 4A depicts exemplary matrix profiles and stream flows of pattern discovery, according to one or more embodiments. These may be exemplary outputs of the system described herein including repeated patterns, and include matrix profiles 400a and stream flows 402a of pattern discovery.

Alert data source anomaly detection may be performed with matrix profile. The system described herein may apply matrix profile techniques for time series anomaly detection. This may include computing a distance profile of each subsequence window within a time series, then combining these distance profiles into a matrix profile for example which in one or more embodiments may include matrix profiles 400a, which may also be a vector that stores the minimum distance of each subsequence to all others.

The matrix profile may allow for the system to accomplish two main criteria that my assist with detecting anomalies without relying on sudden spikes or drops in data intake. The two criteria may be repeated patterns (as depicted in FIG. 4A in the highlighted area) and top discords (as depicted in FIG. 4B in the highlighted area).

Alerts may be sent out on intervals whether or not there is a problem. The matrix profile may assist in displaying the patterns. In the matrix profile 400a, the highlighted sections may display a pattern of two spikes that are extremely similar to each other, where the similarity may be a visual similarity or mathematical similarity. The alert data in the two highlighted section may behave in almost the exact same pattern. While conventional systems may pick up a sharp increase in data, the matrix profile may allow the system to compare one time period's spike to all other time period's within the data to see if each particular time period is having a unique flow of data compared to the others. The stream flows 402a may depict how strong the anomaly of the data is through displaying of a higher or lower value matrix profile. The higher the matrix profile, the less likely that time period's data may be conventionally related to any of the data it is being compared to.

FIG. 4B depicts exemplary determine matrix profiles and stream flows of discord discovery, according to one or more embodiments. These may be exemplary outputs of the system described herein including top discords, and include matrix profiles 400b and stream flows 402b of pattern discovery.

The matrix profiling algorithm performed by the system described herein may allow for periods of incoming data to be compared with other periods of incoming data. The higher the value of the matrix profile, the higher the discord, the less similar it may be to all other periods in the time series. Using the discords the system may be configured to determine true anomalies as the alert data comes in that is unlike any of the other alert data coming in without having to rely on sudden spikes or drops. The top discord (stream flows 402b) highlighted in grey and shown with dashed lines within the matrix profile 400b may depict the period of data that is unlike most of all the other periods of data. The high values on matrix profile allow for a user or system to better examine areas that appear anomalous compared to those that are not and give a better idea of whether or not this type of data is expected and seen before or anomalous, and just how anomalous the data is.

FIG. 4A and FIG. 4B may depict a computer-implemented method for processing live streaming data, the method comprising: storing one or more distance profiles of one or more subsequences for a first time series of data, into a matrix profile that is a vector, storing one or more minimum distances between each of the one or more subsequences into the matrix profile, identifying one or more repeated patterns in the first time series of data using a value of the matrix profile at one or more times, identifying one or more top discords in the first time series of data using a value of the matrix profile at the one or more times, stopping one or more false alerts from being sent based on a determination that the first time series of data is made up of the one or more repeated patterns, and outputting one or more alerts based on identification of top discords. FIG. 4A and FIG. 4B may depict a computer-implemented method for processing live streaming data, the method further comprising wherein the matrix profile allows a comparison of one or more time period's data value to previously collected time period's data value to identify if the one or more time period is having a unique flow of data compared to the previously collected time period data, wherein the one or more repeated patterns comprise spikes or drops, wherein a matrix profile with a lower value corresponds with identification of one or more repeated patterns, wherein the one or more top discords comprise sudden spikes or sudden drops, wherein a higher value matrix profile corresponds with identification of one or more top discords, wherein a higher value matrix profile indicates to a user, a higher likelihood that an area that appears anomalous is actually anomalous compared to areas that are not anomalous, and a lower likelihood that an identified area is the type of data expected to be seen or seen before compared to previously time series of data, and wherein the method is implemented using an application programming interface with a unified stream-processing and batch-processing framework.

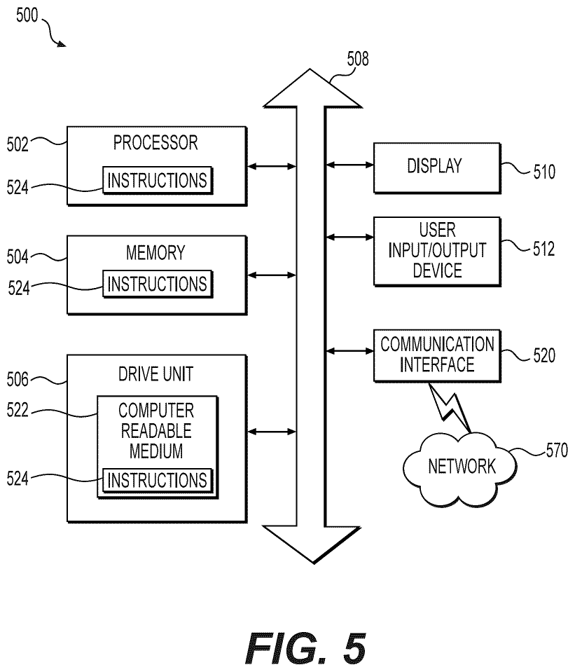

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the programmed processor 502 executing the instructions stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input device 512 configured to allow a user to interact with any of the components of computer system 500. The input device 512 may be a number pad, a keyboard, or a cursor control device, such as a mouse, or a joystick, touch screen display, remote control, or any other device operative to interact with the computer system 500.

The computer system 500 may also or alternatively include a disk drive unit, optical drive unit, or drive unit 506. The drive unit 506 may include a computer-readable medium 522 in which one or more sets of instructions 524, e.g., software, can be embedded. Further, the instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, a computer-readable medium 522 includes instructions 524 or receives and executes instructions 524 responsive to a propagated signal so that a device connected to a network 570 can communicate voice, video, audio, images, or any other data over the network 570. Further, the instructions 524 may be transmitted or received over the network 570 via a communication interface 520, and/or using a bus 508. Communication interface 520 (which may be a communication port or interface) may be a part of the processor 502 or may be a separate component. The communication interface 520 may be created in software or may be a physical connection in hardware. The communication interface 520 may be configured to connect with a network 570, external media, the display 510, or any other components in computer system 500, or combinations thereof. The connection with the network 570 may be a physical connection, such as a wired Ethernet connection or may be established wirelessly as discussed below. Likewise, the additional connections with other components of the computer system 500 may be physical connections or may be established wirelessly. The network 570 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 500 may be connected to one or more networks, which may include network 570. The network 570 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 570 may include wide area networks (WAN), such as the Internet, local area networks (LAN), campus area networks, metropolitan area networks, a direct connection such as through a Universal Serial Bus (USB) port, or any other networks that may allow for data communication. The network 570 may be configured to couple one computing device to another computing device to enable communication of data between the devices. The network 570 may generally be enabled to employ any form of machine-readable media for communicating information from one device to another. The network 570 may include communication methods by which information may travel between computing devices. The network 570 may be divided into sub-networks. The sub-networks may allow access to all of the other components connected thereto or the sub-networks may restrict access between the components. The network 570 may be regarded as a public or private network connection and may include, for example, a virtual private network or an encryption or other security mechanism employed over the public Internet, or the like.

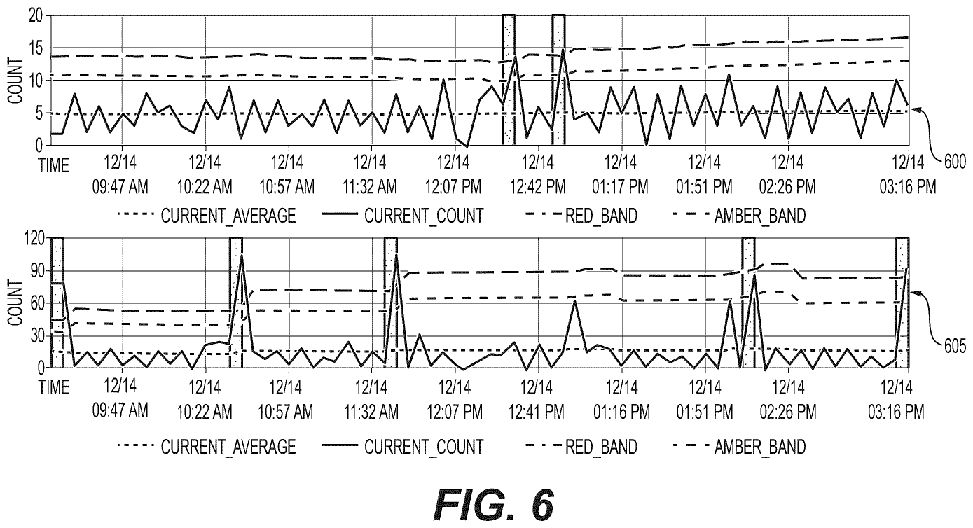

FIG. 6 depicts graphs of time series of data, according to one or more embodiments. The graphs may include graph 600 and graph 605 including current_avg, current_count, red_band, and amber_band data. Graph 600 and graph 605 may also include one or more highlighted anomalies. Graph 600 and 605 may also include count values for time synchronized time series of data after data has been windowed. On the x-axis of graph 600 and graph 605, time may be depicted, with corresponding time stamps. On the y-axis of graph 600 and graph 605, count may be depicted, with corresponding values. Graph 600 and graph 605 may include current_avg which is the current average of displayed data. Graph 600 and graph 605 may include current_count which is the count collected for data at each time. Graph 600 and graph 605 also may include red_band and amber_band. Graph 600 and graph 605 may include highlighting to indicate the presence or identification of anomalous data, or lack thereof.

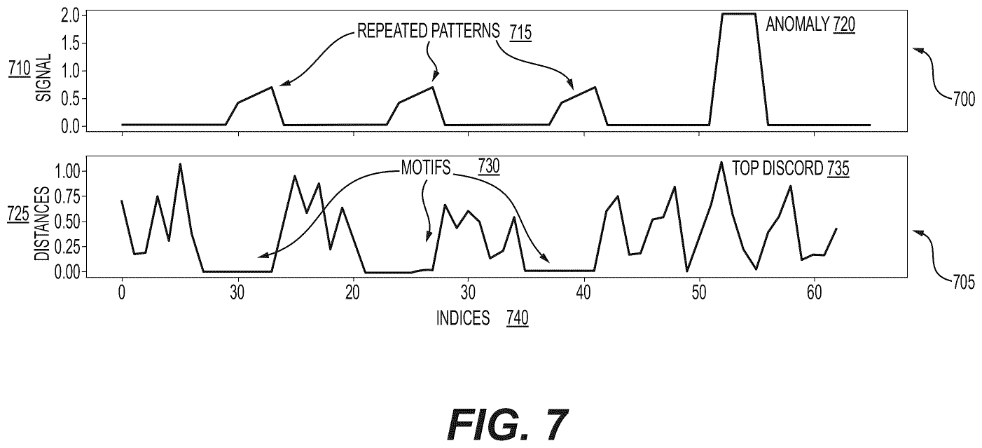

FIG. 7 depicts exemplary determine matrix profiles and stream profiles, according to one or more embodiments. Graphs, matrix profiles, and stream profiles may include graph 700, graph 705, signal 710, repeated patterns 715, anomaly 720, distances 725, motifs 730, top discord 735, and indices 740. Signal 710 may be an axis of a graph. Distances 725 may be an axis of a graph. Indices 740 may be an axis of a graph. Low value motifs 730 may indicate the presence of repeated patterns 715, which may indicate the absence of anomaly for that section of a time series of data or data stream. High value motifs may indicate top discord 735 which may indicate the presence of anomaly 720.

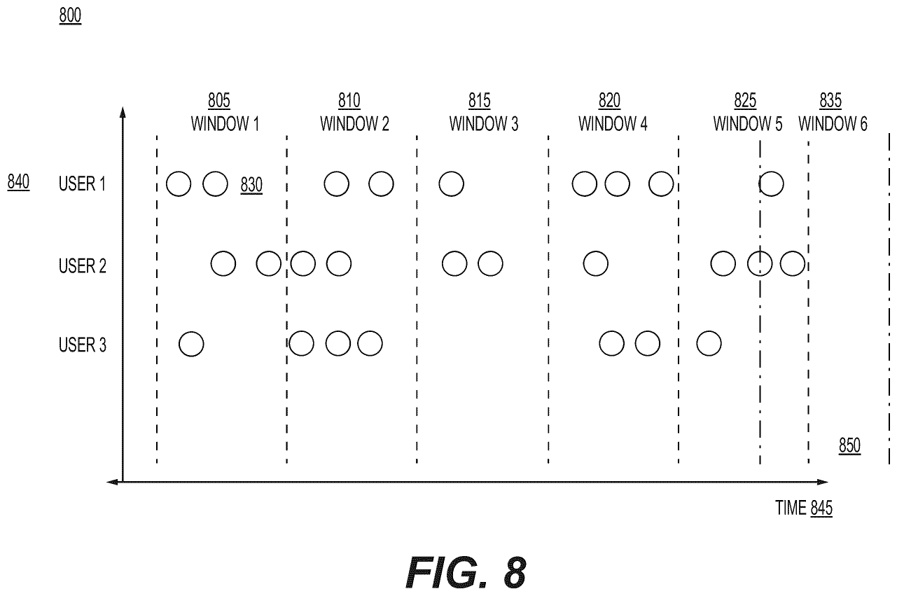

FIG. 8 depicts a graph of sliding windows implemented by the system herein, according to one or more embodiments. Windows 800 may include window 1 805, window 2 810, window 3 815, window 4 820, window 5 825, data 830, window 835, user 1 840, time 845, multiple other users, or multiple other windows. Window 1 805, window 2 810, window 3 815, window 4 820, window 5 825, and window 835 may be sliding windows, and windows may slide by a fixed period to accommodate new data points. Window 6 may perform a sliding function 850.

For example sliding windows may include flexibility with windowing. For example, sliding windows may include having a 10 minute window sample for time 845, not having 10 sliding windows, but instead having a window between 1 minutes and 2 minutes which may be window 1 805, then 2 minutes and 3 minutes which may be window 2 810, then 3 minutes and 4 minutes which may be window 3 815, incrementing by a time stamp, across the entire 10 minute window sample. In one or more embodiments, sliding windows may include window 1 which is between 1 minute and 2 minutes of the 10 minute window. In one or more embodiments, sliding windows may include a window that is 10 minutes, and one or more sub-windows between 4 minute and 5 minutes which may be window 4 820, 5 minutes and 6 minutes which may be window 5 825, and another time interval distance which may be window 6 835. Sliding function 850 may allow window 6 835 to perform as a sliding window.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for processing live streaming data, the method comprising:
assigning one or more data to one or more windows based on one or more group level characteristics of the one or more data;
assigning the one or more data to one or more sub-windows based on one or more time stamps, the one or more sub-windows inside the windows;
creating a data count for each of the sub-windows, wherein the data count is a scalar value;
creating a first time series from the data count of each of the sub-windows, wherein the first time series of the data is a real-time synchronous time series of data;
comparing the time series to a second time series of data, wherein the second time series of data is previous time series data;
identifying presence of one or more anomalies based on the comparison of first time series to the second time series, wherein the comparison is based on comparison of the scalar values;
alerting a user to the presence of one or more anomalies based on a result of the comparison; and
modifying the second time series based on the first time series.

2. The method of claim 1, wherein the method is implemented using an application programming interface with a unified stream-processing and batch-processing framework.

3. The method of claim 1, wherein the sub-windows are fixed size, non-overlapping, contiguous time interval windows.

4. The method of claim 1, wherein the sub-windows are sliding windows.

5. The method of claim 1, wherein group level characteristics include impacted data centers, configurable item category, impacted locations, impacted line of businesses, and impacted alert sources.

6. The method of claim 1, wherein the one or more windows is seven days.

7. The method of claim 1, wherein the one or more windows is twenty-four hours.

8. The method of claim 1, wherein a time interval of the one or more sub-windows is five minutes or less.

9. The method of claim 1, wherein the second time series is a mathematical average of previously collected time series data.

10. The method of claim 1, wherein the comparing comprises comparing the first time series with the second time series at every sub-window interval.

11. The method of claim 1, wherein the comparing comprising comparing the first time series with the second time series at a user specified time interval.

12. A computer-implemented method for processing live streaming data, the method comprising:
storing one or more distance profiles of one or more subsequences for a first time series of data, into a matrix profile that is a vector;
storing one or more minimum distances between each of the one or more subsequences into the matrix profile;
identifying one or more repeated patterns in the first time series of data using a value of the matrix profile at one or more times;
identifying one or more top discords in the first time series of data using a value of the matrix profile at the one or more times;
stopping one or more false alerts from being sent based on a determination that the first time series of data is made up of the one or more repeated patterns; and
outputting one or more alerts based on identification of top discords.

13. The method of claim 12, wherein the matrix profile allows a comparison of one or more time period's data value to previously collected time period's data value to identify if the one or more time period is having a unique flow of data compared to the previously collected time period data.

14. The method of claim 12, wherein the one or more repeated patterns comprise spikes or drops.

15. The method of claim 12, wherein a matrix profile with a lower value corresponds with identification of one or more repeated patterns.

16. The method of claim 12, wherein the one or more top discords comprise sudden spikes or sudden drops.

17. The method of claim 12, wherein a higher value matrix profile corresponds with identification of one or more top discords.

18. The method of claim 12, wherein a higher value matrix profile indicates to a user,
a higher likelihood that an area that appears anomalous is actually anomalous compared to areas that are not anomalous; and
a lower likelihood that an identified area is the type of data expected to be seen or seen before compared to previously time series of data.

19. The method of claim 12, wherein the method is implemented using an application programming interface with a unified stream-processing and batch-processing framework.

20. A system for determining group-level anomalies for information technology events, the system comprising:
a memory having processor-readable instructions stored therein; and
at least one processor configured to access the memory and execute the processor-readable instructions to perform operations including:
assigning one or more data to one or more windows based on one or more group level characteristics of the one or more data;
assigning the one or more data to one or more sub-windows based on one or more time stamps, the one or more sub-windows inside the windows;
creating a data count for each of the sub-windows, wherein the data count is a scalar value;
creating a first time series from the data count of each of the sub-windows, wherein the first time series of the data is a real-time synchronous time series of data;
comparing the time series to a second time series of data, wherein the second time series of data is previous time series data;
identifying presence of one or more anomalies based on the comparison of first time series to the second time series, wherein the comparison is based on comparison of the scalar values;
alerting a user to the presence of one or more anomalies based on a result of the comparison;
modifying the second time series based on the first time series;
storing one or more distance profiles of one or more subsequences for the first time series of data, into a matrix profile that is a vector;
storing one or more minimum distances between each of the one or more subsequences into the matrix profile;
identifying one or more repeated patterns in the first time series of data using a value of the matrix profile at one or more times;
identifying one or more top discords in the first time series of data using a value of the matrix profile at the one or more times;
stopping one or more false alerts from being sent based on a determination that the first time series of data is made up of the one or more repeated patterns; and
outputting one or more alerts based on identification of top discords.
